(19) United States
(12) Patent Application Publication
(10) Pub. No.: US 2012/0258728 A1
(43) Pub. Date: Oct. 11, 2012

(54) Cell Phone Interactive Device

(76) Inventors: Brian William Seal, Fond du Lac, WI (US); Lori Ann Mundt, Fond du Lac, WI (US)

(21) Appl. No.: 13/083,292

(22) Filed: Apr. 8, 2011

(51) Int. Cl. H04M 1/00; H04W 24/00

(52) U.S. Cl. 455/456.1; 455/572; 455/566

(57) ABSTRACT

A cell phone interaction device which communicates with a cell phone. The cell phone interaction device allows a user to locate a misplaced cell phone by signaling the cell phone to produce an audible, physical, or visual signal that aids the user in locating the misplaced cell phone.

### CROSS-REFERENCE TO RELATED APPLICATIONS

This application claims priority to U.S. Provisional Application No. 61/070,359, filed on Mar. 20, 2008, and U.S. Nonprovisional application Ser. No. 12/381,752, filed on Mar. 16, 2009, herein incorporated by reference.

### FIELD OF INVENTION

The present invention relates to the field of remote control devices and more specifically to a device which interacts with a cell phone.

### BRIEF DESCRIPTION OF THE DRAWINGS

FIG. 1 illustrates an exemplary system diagram of a cell phone interactive system in which the interactive device is a keychain.

FIGS. 2a and 2b illustrate exemplary embodiments of an interactive device capable of communicating remotely with a cell phone and receiving a mutually agreed to signal associated with an identified cell phone.

FIGS. 3a and 3b illustrate exemplary embodiments of an external mount assembly for externally mounting communication components to a cell phone for use in an exemplary cell phone interactive system.

FIGS. 4a and 4b illustrate exemplary placement of internally mounted components on the inner surface of a cell phone battery cover for use in an exemplary cell phone interactive system.

FIGS. 5a and 5b illustrate exemplary structural configurations of a battery cover adapted for mounting components within a cell phone housing for use in an exemplary cell phone interactive system.

FIG. 6a illustrates exemplary components of a system which displays caller identification information for incoming calls on a cell phone interactive device.

FIG. 6b illustrates exemplary components of a system which displays location data for a cell phone on a cell phone interactive device.

FIG. 7 illustrates exemplary components of a system which inter-operatively interacts with electronic locking systems.

### TERMINOLOGY

As used herein, the term “caller identification data” refers to data which identifies a caller.

As used herein, the term “cell phone interactive device” or “interactive device” refers to any electronic device which may be associated with a cell phone. A cell phone interactive device may or may not have the ability to make outgoing calls. Cell phone interactive devices may also have dimensions smaller than an associated cell phone.

As used herein, the term “digital information” refers to information which may be displayed by a cell phone interactive device. Digital information may include, but is not limited to, location data and caller identification data. Digital information may be transmitted in any other format known in the art.

As used herein, the term “display component” refers to an interface on which a phone number, text message, missed call message, GPS coordinates, or another piece of information may be visible.

As used herein, the term “identified signal” refers to an electronic communication signal that is at least in one way identified with an associated cell phone, including but not limited to subscriber identity module (SIM) card identifying number or other quasi-unique identification number or other identifying system known in the art. An identified signal may be formatted to transfer information.

As used herein, the term “location data” refers to data which provides information regarding the location of a cell phone.

As used herein, the term “operatively coupled” means two or more components which are configured to function integrally with one another with or without a physical connection.

As used herein, the term “quasi-unique identification number” refers to a means of identifying a specific device, including, but not limited to, a series of numbers stored on a SIM card which authenticate and identify a specific mobile device, an authenticating program or any other identification means known in the art which may authenticate and identify a specific mobile device.

As used herein, the term “signaling component” refers to a component capable of producing an audible, physical, or visual indication.

As used herein, the term “structural interlocking component” refers to elements used to secure two or more components together, including but not limited to clamps, grooves, straps, adhesive, hook-and-loop fasteners, and materials attracted by magnetic force.

### BACKGROUND

Individuals are increasingly reliant on their cell phones, and it is currently estimated that there are over 5 billion cell phones in use worldwide. Cell phone use has caused specific habits and social norms to develop. For example, many users keep their cell phones with them at all times unless they are specifically prohibited from doing so. There is also an increasing expectation that individuals can be reached in emergency situations by cell phone. Consequently, issues may arise in environments where cell phones are not permitted. For example, school and workplace environments may place restrictions on bringing cell phones on the premises because receiving and making calls may be distracting and/or interfere with tasks. This presents a problem when individuals must be reached in an emergency or notified to contact a third party regarding a work-related or authorized task.

Cell phones are relatively small devices that are easily dropped or inadvertently left in an unknown location. Numerous issues are presented when a user misplaces a cell phone. If the cell phone is out-of-battery or not close by, the individual cannot simply call the cell phone to locate it. A dead cell phone battery may also result in an inability to reach the cell phone owner in an emergency.

Since considerable data and information may be stored on a cell phone, a lost cell phone can result is a loss of privacy and security for the owner. It may be critical to locate a misplaced cell phone. Data loss (e.g., sales contacts) may be costly to a business user, and some data may not be easily retrievable.

Devices used to track lost cell phones are known in the art. One example is disclosed in U.S. application Ser. No. 09/946,793 (Merrem '793). Merrem '793 teaches a personal digital assistant (PDA) protection system that alerts a user if his or her PDA is located at a distance which exceeds a predetermined threshold. The PDA protection system contains a transmitting apparatus that provides a signal, and a receiving apparatus that receives the signal to determine whether the PDA has been forgotten. However, this system is only capable only of alerting a user if the distance between the transmitting apparatus and the receiving apparatus has been exceeded.

In addition, many environments restrict the use of a cellular device or require a user to relinquish a device entirely while on the premises. Prior art has been directed to limiting the use of cell phones in certain environments. U.S. Pat. No. 7,110,753 (Campen '753) is directed to a system and method for remotely controlling functional aspects of a wireless device. The system and method taught by Campen '753 is complex because it requires an administrator or third party to create control parameters for the use of the cell phone.

It is also known, based on market research, that cell phones are commonly kept with a user (e.g., in a pocket or purse). A cell phone is an object that is more frequently and uniformly within reach of users than most other possessions.

It is desirable to have a device capable of locating a misplaced cell phone, particularly when a battery has lost power.

It is desirable to have a device capable of communicating with a cell phone.

It is further desirable to have a device which can be used in place of a cell phone in areas where cell phones are prohibited.

### SUMMARY OF THE INVENTION

The present invention is a cell phone interactive device comprised of a housing component, a power source, a receiver capable of receiving a signal associated with a specific cell phone, and at least one signaling component for alerting a user that the cell phone has received a signal. The receiver and signaling component are operatively coupled to the power source. A battery/power source, transceiver, and signaling component are mounted to an internal or external surface of a cell phone housing, allowing the interactive device and the cell phone to communicate.

### DETAILED DESCRIPTION OF INVENTION

For the purpose of promoting an understanding of the present invention, references are made in the text to exemplary embodiments of a cell phone interactive device, only some of which are described herein. It should be understood that no limitations on the scope of the invention are intended by describing these exemplary embodiments. One of ordinary skill in the art will readily appreciate that alternate but functionally equivalent materials and configurations may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

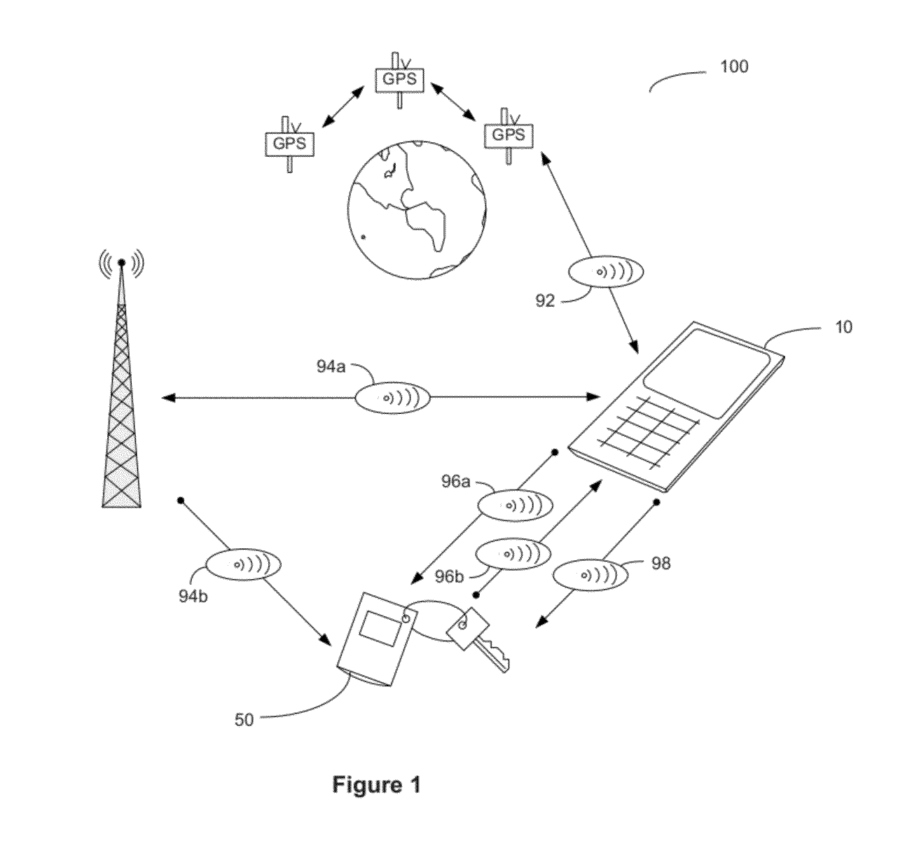

FIG. 1 illustrates an exemplary system diagram of cell phone interactive system 100 in which interactive device 50 is designed to be mounted on a keychain thus allowing interactive device 50 to communicate with cell phone 10 for purposes of locating cell phone 10 or for being alerted when cell phone 10 receives an incoming signal (e.g., call or text).

In various embodiments, interactive device 50 may communicate with cell phone 10 via signals 98 transmitted from cell phone 10 to interactive device 50 and/or interactive device 50 may communicate interactively with cell phone 10 through signals 96a and 96b emitted from paging component 40 (not shown) in cell phone 10 and paging component 60 (not shown) in interactive device, respectively.

In other embodiments, interactive device 50 may receive signals 94b from a cell phone tower as mutually established between interactive device 50 and cell phone 10 when interactive device 50 is associated with cell phone 10. In an exemplary embodiment, interactive device 50 is associated with a quasi-unique identifying number which corresponds to the identifying information on the SIM card of cell phone 10, allowing interactive device 50 to receive signals designated for cell phone 10.

In still other embodiments, cell phone 10 may be in communication with a GPS satellite through GPS signal 92 and may be programmed to broadcast an automatic reading of its coordinates to a cell phone tower via signal 94a. Signal 94a is transformed into signal 94b, which is demodulated, interpreted, and displayed by interactive device 50. In various embodiments, cell phone 10 may be programmed to directly broadcast identified signals which may be directly received by interactive device 50.

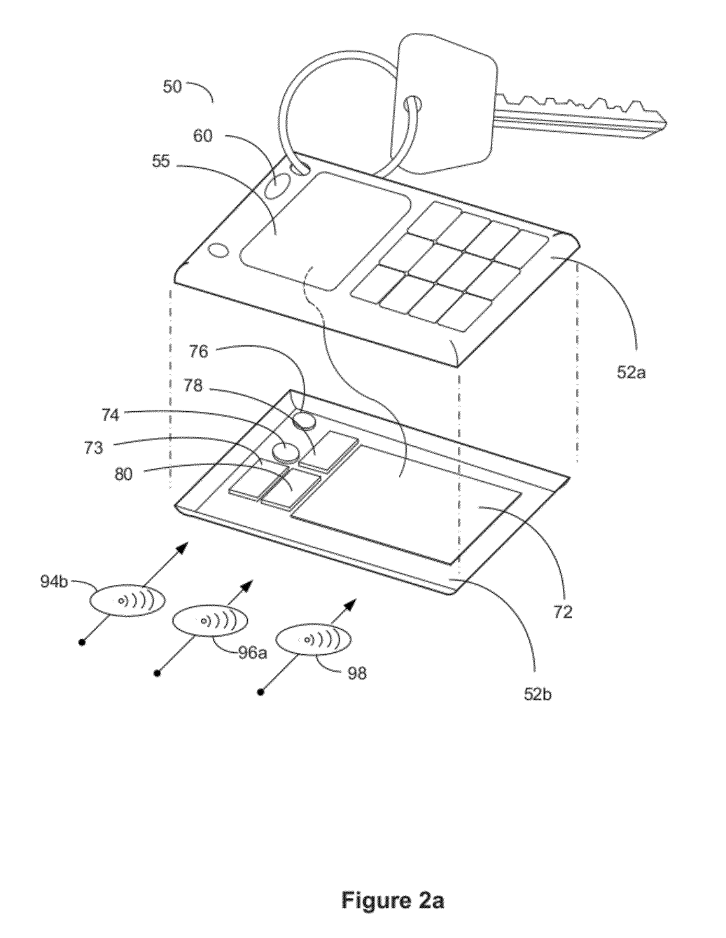

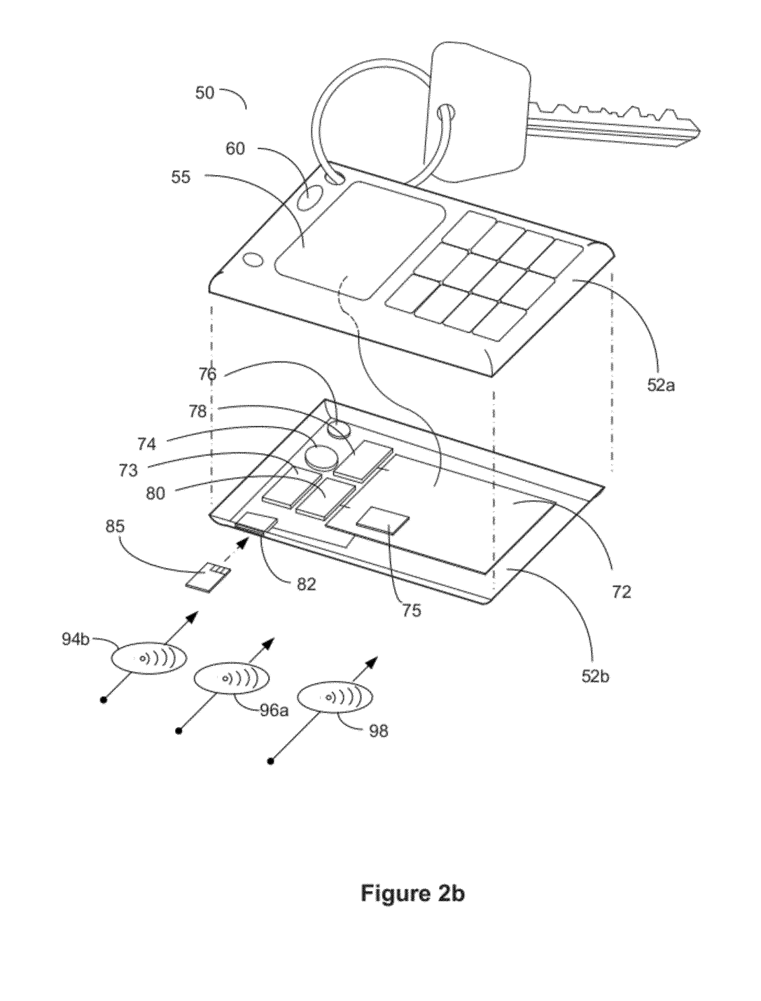

FIGS. 2a and 2b illustrate exemplary embodiments of interactive device 50 capable of communicating remotely with cell phone 10 (not shown). In the embodiments shown, interactive device 50 is adapted to be attached to a key ring.

In the embodiment shown in FIG. 2a, interactive device 50 is comprised of upper housing 52a and lower housing 52b. Located on the outer surface of upper housing 52a is display component 55 and paging component 60. Secured to the inner surface of lower housing 52b are circuit board 72, receiver 80, transmitter 73, signaling component 74, battery/power source 76, and demodulator 78.

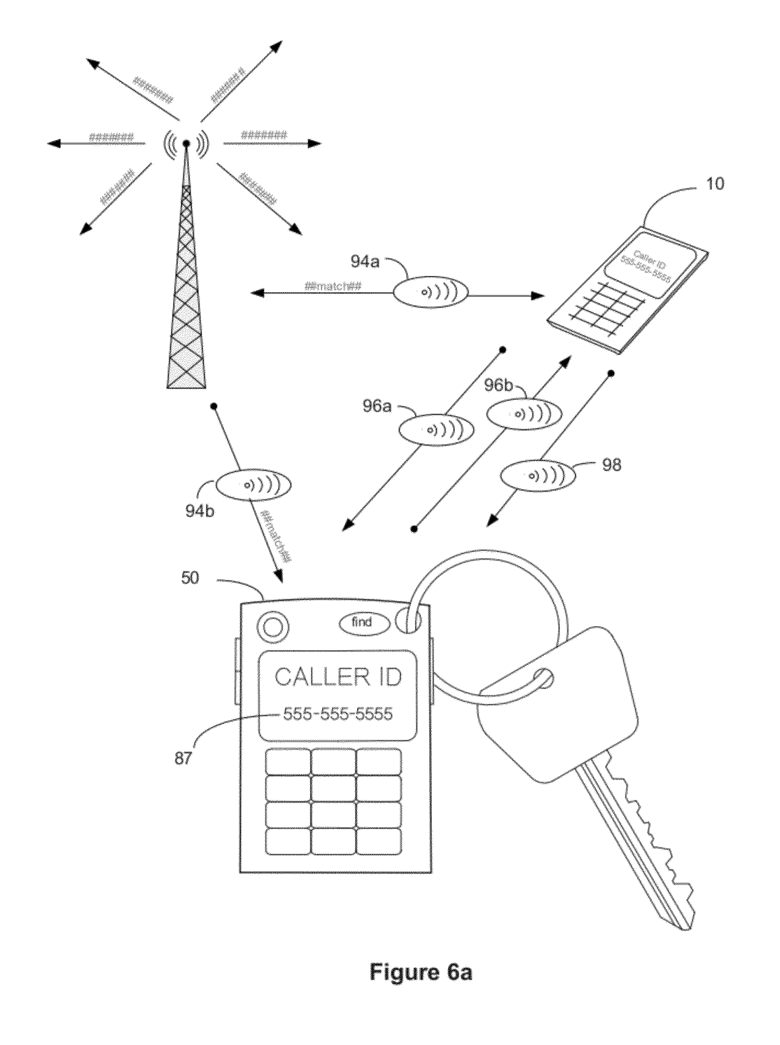

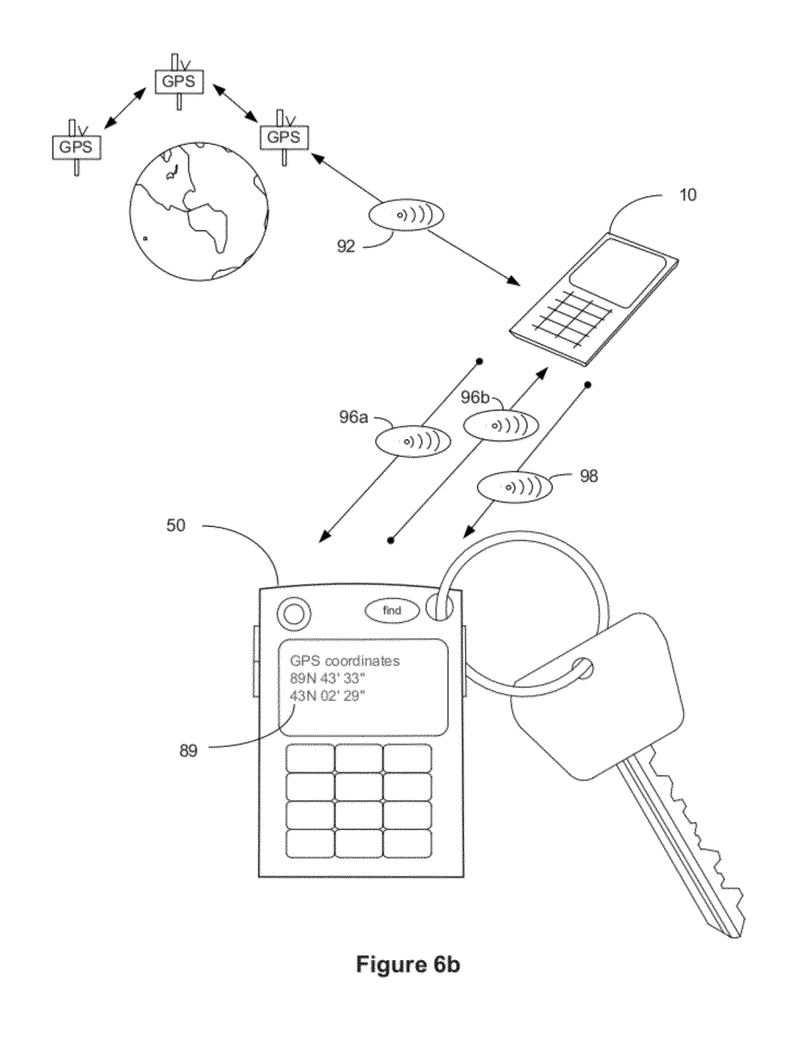

In the embodiment shown, receiver 80 is capable of receiving indentified signals 94b, 96a, and 98 (from a cell tower, cell phone paging component 40, and cell phone 10, respectively). Demodulator 78 receives identified signal 94a, 96a, 98 (i.e., a radio transmission containing data associated with a quasi-unique identification number), extracts the information from the identified signal, and displays it on display component 55. In an exemplary embodiment, the information displayed is caller identification information (FIG. 6a) or location data (FIG. 6b). In various embodiments, data contained within an identified signal may include but is not limited to text messages, caller identification information, and any other data capable of being communicated with a radio transmission (e.g., from a cell phone, satellite, computer, or other device containing a modulator for sending such signals).

In various embodiments, transmitter 73 may be a modulator or any device capable of sending an electronic transmission.

In various embodiments, demodulator 78 may be a full-duplex demodulator (i.e., capable of two-way simultaneous transmission) or a half-duplex demodulator (i.e., capable of transmitting only one way at a time).

In the embodiment shown, battery/power source 76 is a watch battery; however, in various other embodiments, battery/power source 76 may be another type of battery or power source known in the art. In further exemplary embodiments, battery/power source 76 may be any lithium, nickel or alkaline battery known in the art. In still further exemplary embodiments, battery/power source 76 may be an RFID (or radio-frequency identification) tag. Batteries/power sources may be disposable or rechargeable through any method known in the art, including direct charging (i.e., through a wall outlet), indirect charging (i.e., e-coupling to an exterior power source or cell phone 10 itself), and solar charging. If battery/power source 76 is charged by e-coupling to cell phone 10, the battery in cell phone 10 may contain a transmitting device.

In the embodiment shown in FIG. 2b, interactive device 50 further includes memory component 75, port 82, and SIM card 85. In an exemplary embodiment, SIM card 85 is formatted with the quasi-unique identification number of cell phone 10 using a method known in the art, allowing information to be transferred from cell phone 10 to interactive device 50 and stored on memory component 75. In various other embodiments, receiver 80 and transmitter 73 are replaced with a transceiver, which allows interactive device 10 to send a signal to cell phone 10 either directly or indirectly (e.g., via a cell phone tower).

In the exemplary embodiment shown, interactive device 50 is a keychain device; however, in other embodiments, interactive device 50 may be any lightweight, compact device easily carried by an individual or stored in a pocket or purse. For example, interactive device 50 may be a device small enough to be easily carried by a runner or sports participant when it is impractical to carry a heavier, larger device, such as a cell phone, or when the individual is concerned about losing his or her cell phone.

In various other embodiments, interactive device 50 may further include one or more processing components capable of functions including but not limited to processing GPS coordinates, controlling timing and calendar components, controlling alarms and alerts, blocking data, converting signals into data, and changing display formats. In still other embodiments, interactive device 50 may be integrated with the operating system of cell phone 10.

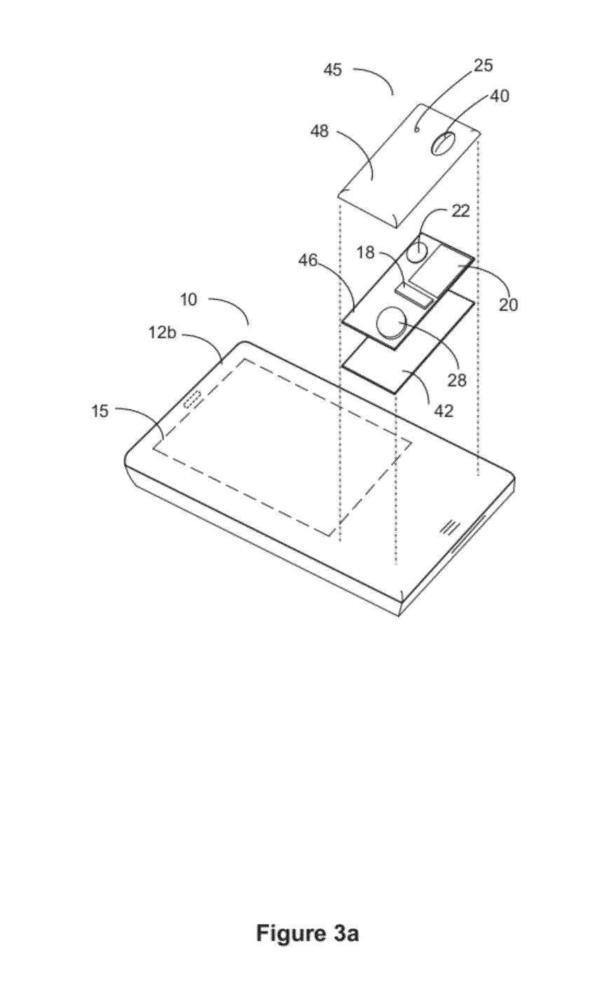

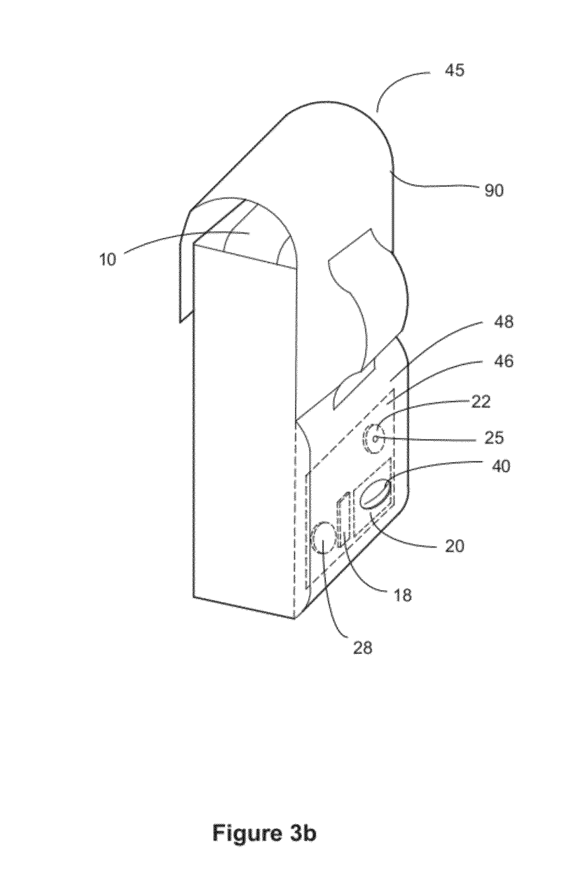

FIGS. 3a and 3b illustrate exemplary embodiments of an external mount assembly for externally mounting communication components to cell phone 10 for use in cell phone interactive system 100. In FIG. 3a, the communication components are mounted on an external surface of cell phone 10; in FIG. 3b, the communication components are mounted inside a cell phone case.

In the embodiment shown in FIG. 3a, external mount assembly 45 is comprised of base 46 and cover 48. Secured to base 46 are circuit board 20, battery/power source 28, transceiver 18, and signaling component 22. Cover 48 includes aperture 25 and paging component 40.

Circuit board 20 controls signaling component 22. In an exemplary embodiment, signaling component 22 is capable of producing an audible, physical, or visual indication. For example, an audible signal may include but is not limited to a chirp, beep, buzz, ring tone, song, and a recorded voice; a physical signal may include but is not limited to vibration; and a visual signal may include but is not limited to a blinking light.

In the embodiment shown, circuit board 20 is an LED circuit board known in the art configured to modulate, demodulate, or direct electronic signals and control components, such as displays, power switches, and volume controls.

In the embodiment shown, base 46 is secured to battery cover outer surface 12b of cell phone 10 using adhesive 42. Cover 48 is then positioned over base 46 and secured (e.g., using adhesive placed around the edges of cover 48). When external mount assembly 45 is assembled, aperture 25 in cover 48 is centered over signaling component 22, enabling signaling component 22 to be heard. In an exemplary embodiment, external mount assembly 45 is positioned so that it does not interfere with antenna 15 located on the battery cover inner surface.

In the embodiment shown, adhesive 42 is double-sided tape. In other embodiments, external mount assembly 45 is assembled and secured to cell phone 10 using another method known in the art. For example, external mount assembly 45 may secured to cell phone 10 or a cell phone case using structural interlocking components, such as clamps, grooves, straps, hook-and-loop fasteners, and magnets.

In the embodiment shown in FIG. 3b, base 46 with attached circuit board 20, battery/power source 28, transceiver 18, and signaling component 22 are configured inside case 90. Paging component 40 is secured to the outside of case (so that positioned over circuit board 20). The outside of case 90 further includes aperture 25 positioned over signaling component 22. Cover 48 includes aperture 25 and paging component 40.

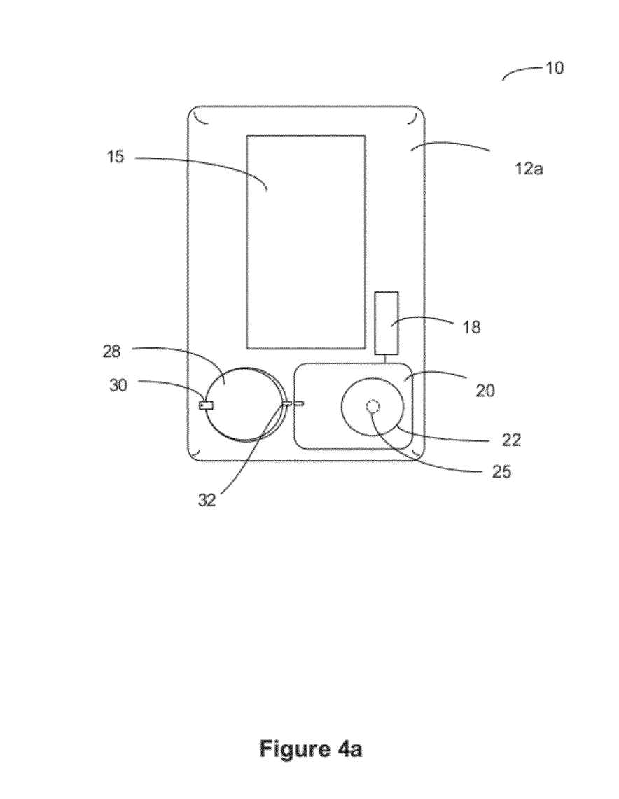

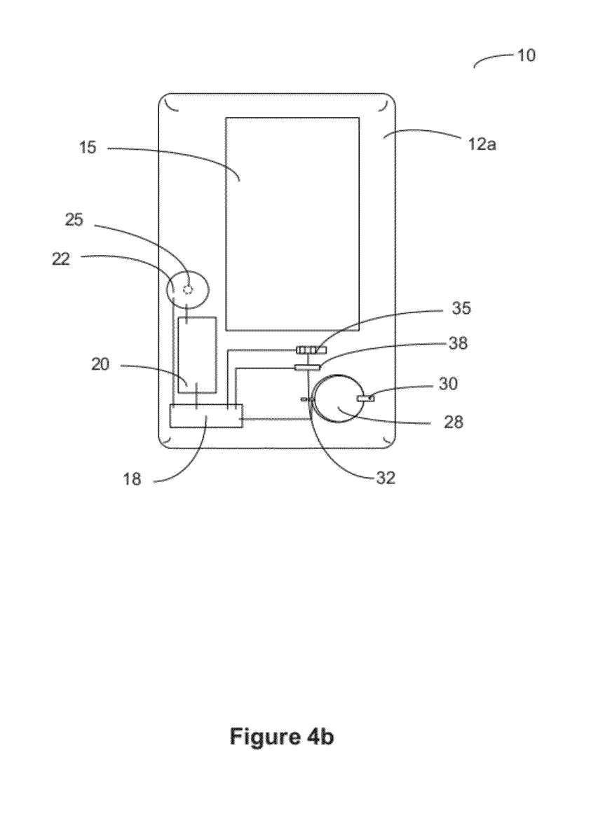

FIGS. 4a and 4b illustrate exemplary placement of internally mounted components on battery cover inner surface 12a for use in cell phone interactive system 100. In an exemplary embodiment of cell phone interactive system 100, the battery cover of cell phone 10 is removed and replaced with a battery cover with internally mounted components on battery cover inner surface 12a.

In the embodiment shown in FIG. 4a, antenna 15, transceiver 18, circuit board 20, signaling component 22, battery/power source 28, and terminals 32 are mounted to battery cover inner surface 12a.

In the embodiment shown in FIG. 4b, the positioning of antenna 15, transceiver 18, circuit board 20, signaling component 22, battery/power source 28, and terminals 32 differ from that illustrated in FIG. 4a. In addition, in FIG. 4b, battery cover inner surface 12a further includes primary battery connection 35 and relay switch 38. Primary battery connection allows the components mounted to battery cover inner surface 12a to be powered off of the cell phone's battery in addition to or instead of battery/power source 28. Relay switch 38 is used to designate which battery(ies) are being used as a power source. Relay switch 38 may select between using battery/power source 28 or the cell phone's battery to power internally mounted components shown in FIG. 4b. In further exemplary embodiments, relay switch 38 may be used to power cell phone 10 off of battery/power source 28. In still further exemplary embodiments, battery cover of cell phone 10 may contain a harness or plug that works in conjunction with the cell phone's battery.

In both embodiments shown in FIGS. 4a and 4b, the components mounted on battery cover inner surface 12a are positioned so they do not interfere with antenna 15.

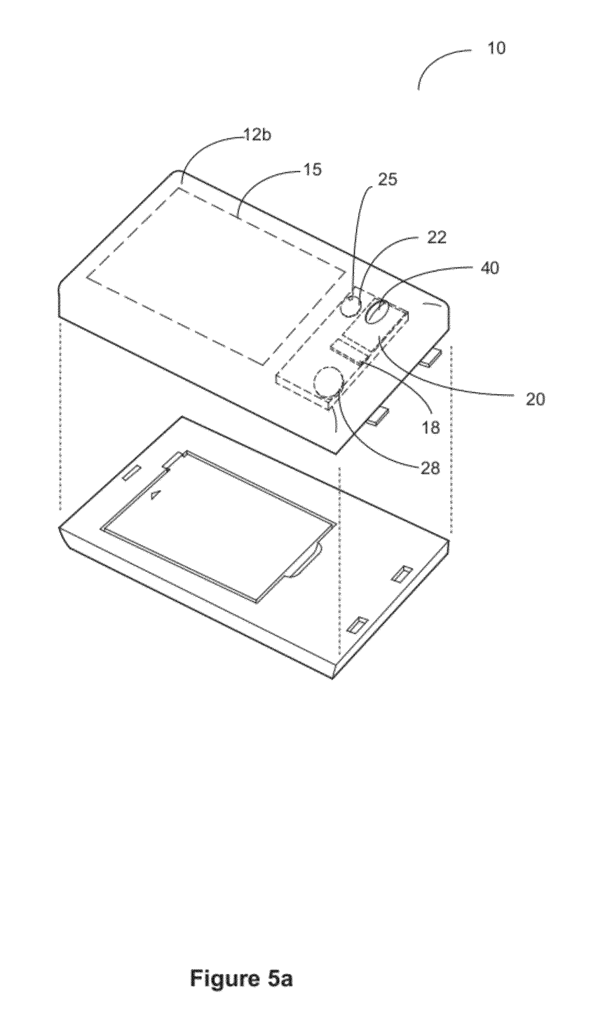

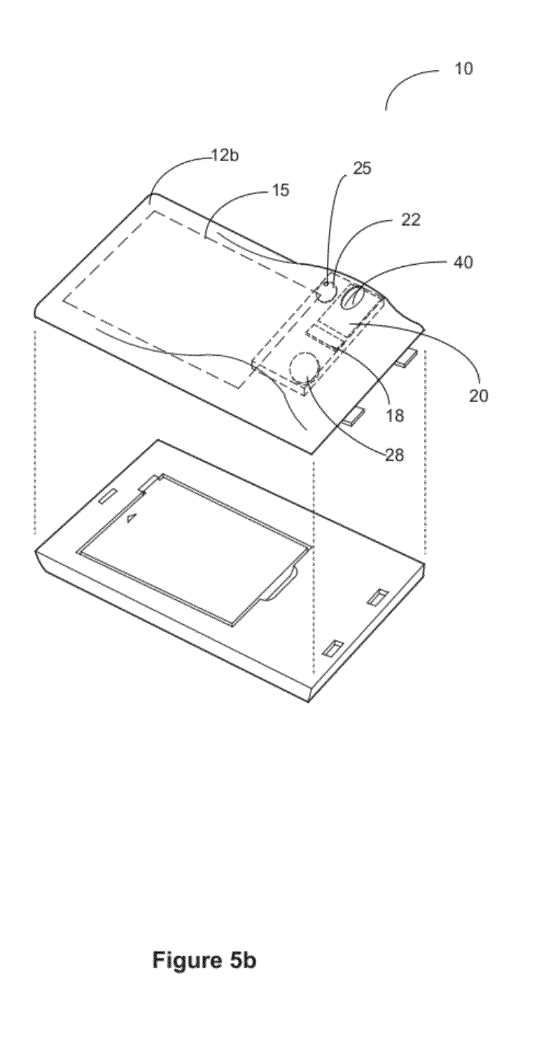

FIGS. 5a and 5b illustrate exemplary structural configurations of a battery cover adapted for mounting components within a cell phone housing for use in an exemplary cell phone interactive system 100. In the embodiment shown in FIG. 5a, cell phone battery cover 12b has a uniform thickness whereas the cover shown in FIG. 5b has a protruding portion which accommodates transceiver 18, circuit board 20, signaling component 22, and battery/power source 28. Also visible in FIGS. 5a and 5b are aperture 25 and paging component 40. As shown in FIGS. 5a and 5b, transceiver 18, circuit board 20, signaling component 22, paging component 40, aperture 25 and battery/power source 28 are arranged to not interfere with antenna 15.

FIG. 6a illustrates exemplary components of a system which displays caller identification information 87 for incoming calls on a cell phone interactive device 50.

In the embodiment shown, when cell phone 10 receives a radio frequency signal (signal 94a) associated with its quasi-unique identification number, cell phone 10 sends signal 98 directly to interactive device 50 and caller identification data 87 appears on the display component of interactive device 50. In the embodiment shown, interactive device 50 further includes a SIM card 85 (not visible) associated with the same quasi-unique identification number as cell phone 50, allowing interactive device 50 to receive a radio frequency signal (signal 94b) directly from the cell tower.

FIG. 6b illustrates exemplary components of a system which displays location data 89 for a cell phone on a cell phone interactive device 50. In the embodiment shown, cell phone 10 is configured with GPS software so that when cell phone 10 receives an incoming call, text message, or another type of signal, the GPS coordinates of cell phone 10 are broadcast via satellite (signal 92) to cell phone 10, which then broadcasts the GPS coordinates to interactive device 10 (signal 98) so that location data 89 appears on the display component of interactive device 50.

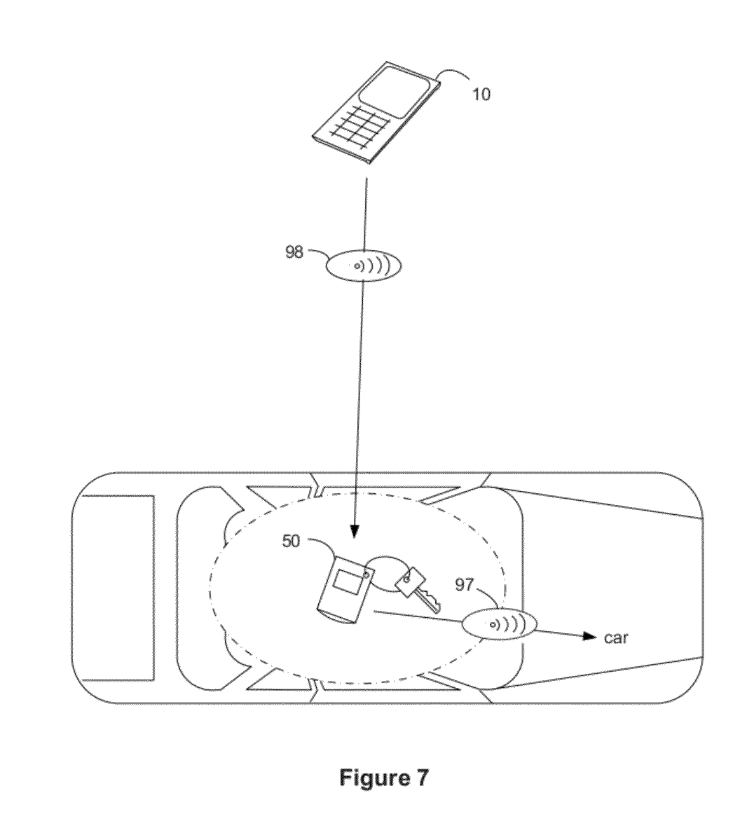

FIG. 7 illustrates exemplary components of cell phone interactive system 100 which inter-operatively interacts with electronic locking systems. In the embodiment shown, interactive device 50 interacts with a commercially available remote locking device. If the user locks his or her keys in the car, cell phone 10 may be used to send a signal (signal 98) to interactive device 50. Cell phone 10 identifies the specific frequency of the signal, opening and closing a circuit which activates the electronic locking mechanism in the car (signal 97), unlocking the car door.

In various other embodiments, interactive device 50 may be able to lock/unlock the car doors from the outside of the car, allowing a user to leave his or her keys in the car and take only interactive device 50.

What is claimed is:

1. A cell phone interactive device comprised of:
a housing component;
a power source;
at least one receiver attached to said housing component, said at least one receiver capable of receiving at least one signal associated with a specific cell phone having a quasi-unique identification number for receiving radio frequency signals associated with said quasi-unique identification number, said receiver being operatively coupled to said power source; and
at least one signaling component for a alerting a user that said at least one signal has been received, said signaling component being operatively coupled to said power source.

2. The device of claim of 1 which further includes a demodulator configured to said at least one receiver to receive radio frequency signals associated with said quasi-unique identification number and to display digital information.

3. The device of claim 2 wherein said demodulator is a half-duplex demodulator.

4. The device of claim 2 wherein said demodulator is a full-duplex demodulator.

5. The device of claim 2 wherein said digital information is caller identification data.

6. The device of claim 2 wherein said digital information is location data.

7. The device of claim 1 wherein said at least one signal is a text message.

8. The device of claim 1 wherein said at least one signaling component is a component which emits a signal.

9. The device of claim 8 wherein said signal is a visual signal.

10. The device of claim 8 wherein said signal is an electronic signal emitted by a transmitter mounted externally on a cell phone.

11. The device of claim 8 wherein said signal is an electronic signal emitted by a transmitter mounted within a cell phone.

12. The device of claim 1 which further includes an assembly selectively mounted to said a cell phone, said assembly comprised of:
a power source;
at least one transceiver operatively connected to said power source; and
a signaling component operatively connected to said power source.

13. The device of claim 12 wherein said power source, said at least one transceiver, and said signaling component are mounted outside a cell phone housing.

14. The device of claim 12 wherein said power source, said at least one transceiver, and said signaling component are mounted to a cell phone battery cover.

15. The device of claim 12 wherein said power source is positioned so that it does not interfere with an antenna of a cell phone.

16. The device of claim 12 wherein said assembly further includes a relay component capable of selecting between said power source and a cell phone battery.

17. The device of claim 12 wherein said assembly further includes a relay component adapted to power said cell phone using said power source.

18. The device of claim 1 wherein said interactive device is configured with said quasi-unique identification number of said specific cell phone which enables said interactive device to receive and identify a cell phone message to open and close circuit which activates a locking device.

19. The device of claim 1 which further includes a memory component.

20. The device of claim 1 which further includes a processing component.
